(19) United States
(12) Patent Application Publication
(10) Pub. No.: US 2015/0005118 A1
(43) Pub. Date: Jan. 1, 2015

(54) POWER TRANSMISSION DEVICE FOR ELECTRIC VEHICLE INCLUDING CONTINUOUSLY VARIABLE TRANSMISSION

(71) Applicant: Kwang mo Seo, Seoul (KR)

(72) Inventor: Kwang mo Seo, Seoul (KR)

(21) Appl. No.: 14/374,896

(22) PCT Filed: Nov. 26, 2012
(86) PCT No.: PCT/KR2012/010005

§ 371 Date: Jul. 26, 2014

(30) Foreign Application Priority Data
Jan. 27, 2012 (KR) 10-2012-0008134

(51) Int. Cl. F16H 9/16; F16H 61/66; F16H 61/02

(52) U.S. Cl. CPC F16H 9/16; F16H 61/0295; F16H 61/66
USPC 474/13

(57) ABSTRACT

Provided is a power transmission device for an electric vehicle including a continuously variable transmission capable of increasing the energy efficiency and performance of the electric vehicle, further lowering the engine speed of an electric motor required for shifting the continuously variable transmission so as to accelerate the automatic gear shift timing, and further saving energy by applying a V-belt continuously variable transmission to the electric vehicle using the electric motor and providing an appropriate automatic transmission according to the driving state. The power transmission includes a housing, a driving pulley assembly disposed at the driving shaft of the electric motor, a driven pulley assembly disposed at the driven shaft, a V-belt connecting the driving pulley assembly to the driven pulley assembly, and a speed-reducing gear train disposed between the wheel axis, which is rotatably supported in the housing, and the driven shaft.

### TECHNICAL FIELD

The present invention relates to a power transmission device of a two-wheel or four-wheel drive electric vehicle, and more particularly, to a power transmission device for an electric vehicle including a continuously variable transmission, which torque transmitted from a driving shaft of an electric motor into a driven shaft that is disposed on a side of a wheel is automatically adjusted to improve performance and energy efficiency of the electric vehicle.

### BACKGROUND ART

In general, a two-wheel or four-wheel drive electric vehicle uses an electric motor as a power source. Also, a power transmission device constituted by a speed-reducing gear train may be disposed between a driving shaft of an electronic motor and a wheel axis. Thus, high-speed torque of the electronic motor may be reduced by the power transmission device, and then the reduced torque may be transmitted into the wheel to drive the vehicle. Also, since the increase and decrease of the driving speed is performed by control a power supplied into the electric motor to adjust an RPM, a separate transmission may not be disposed in the power transmission device of the electric vehicle that uses the electric motor as a power source.

In the electric vehicle according to the related art, since the separate transmission is not installed, the electric vehicle may not efficiently change in transmission according to the driving speed or load thereof when the vehicle is driven. Thus, the electric vehicle may have low output and energy efficiency when compared to those of a gasoline engine drive vehicle including a transmission.

To supplement electric vehicle's faults, it may be considered that a V-belt continuously variable transmission that is used for the gasoline engine drive vehicle is installed in the power transmission device of the electric vehicle.

FIG. 1 illustrates a power transmission device of a gasoline engine vehicle including a V-belt continuously variable transmission. Here, the V-belt continuously variable transmission is disposed between an engine-side driving shaft 1 and a wheel-side driven shaft 2. Thus, the driving shaft 1 rotates by driving of an engine 3, and the driven shaft 2 receives a rotation force that changes through a continuously variable transmission 4 from the driving shaft 1 to rotate. The rotation force of the driven shaft 2 may be decelerated by a speed-reducing gear train 6 that is disposed between the driven shaft 2 and a wheel axis 5 and then be transmitted into the wheel axis 5.

The V-belt continuously variable transmission 4 is constituted by a driving pulley assembly 7 disposed on the driving shaft 1, a driven pulley assembly 8 disposed on the driven shaft 2, a V-belt 9 connecting the driving pulley assembly to the driven pulley assembly 8, and a clutch assembly 8a disposed on a side of the driven pulley assembly 8. Also, a compression spring 8c is disposed on the driven pulley assembly 8. The compression spring 8c may press one side of a driven pulley so that a width between both sides of the driven pulley is narrowed to generate an adhesion force between the driven pulley assembly 8 and the V-belt 9, thereby transmitting the rotational force.

Thus, when the driving pulley assembly 7 rotates by the rotational force of an engine 3, the driven pulley assembly 8 that is connected to the driving pulley assembly 7 through the V-belt 9 may rotate. If revolution per minute (RPM) of the engine 3 is less than its idling speed (about 2,000 RPM to about 2,500 RPM according to a kind of vehicles), the clutch assembly 8a may be spaced apart from a clutch cap 8b that is fixed to the driven shaft 2 to prevent the rotational force of the driven pulley assembly 8 from being transmitted into the driven shaft 2. Thus, the engine 3 may become to an idling state in which the wheel 5 does not rotate. On the other hand, if the RPM of the engine 3 is greater than the idling speed, the clutch assembly 8a may be closely attached to the clutch cap 8b by a centrifugal force to transmit the rotational force of the driven pulley assembly 8 to the driven shaft 2 and then the rotational force into the wheel axis 5 through the speed-reducing gear train 6, thereby driving the vehicle.

In the change of the vehicle speed, in an initial state, the V-belt 9 may be disposed on the outermost circumference of the driven pulley assembly 9 and the innermost circumference of the driving pulley assembly 7 due to the pressing force of the compression spring 8c disposed on the driven pulley assembly 8. Thus, an initial ration ratio of the driven shaft 2 to the driving shaft 1 may be maintained to about 2.5:1 due to a difference between the diameters of the driving pulley assembly 7 and the driven pulley assembly 8, which support the V-belt. In this state, to change the rotation ratio between both shafts, one side of the driving pulley assembly 7 may be constituted by a variable driving pulley 7a, and a plurality of weighted rollers 7b may be provided on the driving pulley assembly 7. If the RPM of the engine is greater than a gear shift starting speed (about 4,000 RPM to about 5,000 RPM according to a kind of vehicles), the weighted rollers 7b may press the variable driving pulley 7a toward a fixed driving pulley 7c due to centrifugal forces thereof. As a result, the V-belt 9 is pushed toward the outermost circumference thereof while a gap between the variable driving pulley 7a and the fixed driving pulley 7c is narrowed to change the rotation ratio with respect to the driven pulley assembly 8, thereby automatically changing in transmission. Here, when the centrifugal forces of the weighted rollers 7b of the driving pulley assembly 7 are greater than the pressing force of the compression spring 8c of the driven pulley assembly 8 (about 4,000 RPM to about 5,000 RPM according to a kind of vehicles), the vehicle change may change.

However, when the continuously variable transmission 4 for the gasoline engine is applied to the electric vehicle, the gasoline engine includes the clutch assembly 8a so that the power is not transmitted in the idling state. On the other hand, since the electric vehicle that uses the electric motor as a driving source includes a system in which a power supplied from the electric motor is controlled to adjust a speed of the vehicle, energy may be unnecessarily consumed in the idling state.

Also, since the automatic gear shaft is performed at about 4,000 RPM to realize high-speed driving under the low rotation ratio and high fuel efficiency, if it is intend that the electric motor of the electric vehicle rotates at the same RPM as the engine, large energy may be consumed.

### DISCLOSURE OF THE INVENTION

### Technical Problem

To solve the conventional above-described problem, an object of the present invention provides a power transmission device for an electric vehicle including a continuously variable transmission, which is capable of improving energy efficiency and performance of the electric vehicle in the electric vehicle in which a V-belt continuously variable transmission is applied to the electric vehicle that uses an electric motor as a driving source to perform an appropriate automatic transmission according to the driving state.

Also, another object of the present invention provides a power transmission device for an electric vehicle including a continuously variable transmission, which is capable of further reducing an RPM of an electric motor required for shifting the continuously variable transmission to accelerate automatic gear shift timing, further saving energy, and preventing a slip phenomenon from occur between a V-belt and pulley of the continuously variable transmission when the RPM of the electric motor suddenly increases for rapid acceleration during the driving or at an uphill road.

### Technical Solution

To achieve the above-described objects of the prevent invention, a power transmission device of an electric vehicle including a continuously variable transmission includes: a housing; a driving pulley assembly disposed on a driving shaft of the electric motor that is rotatably supported inside the housing; a driven pulley assembly disposed on a driven shaft that is rotatably supported inside the housing; a V-belt connecting the driving pulley assembly to the driven pulley assembly; and a speed-reducing gear train disposed between a wheel axis that is rotatably supported inside the housing and the driven shaft, wherein the driving pulley assembly includes: a pair of first and second driving wheels that face each other; a plurality of weighted rollers disposed on first driving wheel to adjust a gap between the first and second driving wheels by using a centrifugal force that acts when the driving shaft rotates; an elastic pressure mechanism disposed on the second driving wheel to apply an elastic force to the second driving wheel, thereby allowing the V-belt to be closely attached between the first and second driving wheels, wherein the driven pulley assembly includes: a pair of first and second driven wheels; and an elastic pressure mechanism disposed on the second driven wheel to apply an elastic force to the second driven wheel, thereby allowing the V-belt to be closely attached between the first and second driven wheels.

Also, the elastic pressure mechanism of the driving pulley assembly may include: a support plate fixed to an end of the driving shaft; and an elastic spring elastically disposed between the support plate and the second driving wheel.

Also, the elastic pressure mechanism of the driven pulley assembly may include: a fixed plate fixed to an end of the driven shaft; and an elastic spring elastically disposed between the fixed plate and the second driven wheel.

Also, slip prevention mechanisms for preventing slip from occurring with respect to the V-belt may be disposed on the driving pulley assembly and the driven pulley assembly, respectively.

Also, the slip prevention mechanism disposed on the driving pulley assembly may include: an inclined cam groove having a rectangular shape, the inclined cam groove being defined in a boss part of the second driving wheel; and a cam pin fixed to the driving shaft, the cam being guided into the inclined cam groove, wherein the inclined cam groove may be inclined so that, when a rotation speed of the driving shaft is greater than that of the second driving wheel, the cam pin pushes the second driving wheel toward the first driving wheel to allow the second driving wheel to move.

Also, the slip prevention mechanism disposed on the driven pulley assembly may include: an inclined cam groove having a rectangular shape, the inclined cam groove being defined in a boss part of the second driven wheel; and a cam pin fixed to a boss part of the first driven wheel, the cam being guided into the inclined cam groove, wherein the inclined cam groove may be inclined so that, when a rotation speed of the second driven wheel is greater than that of the first driving wheel, the cam pin pushes the second driven wheel toward the first driven wheel to allow the second driven wheel to move.

Also, a plurality of concave grooves may be defined in an outer circumferential surface of each of the weighted roller.

### Advantageous Effects

According to the power transmission device of the present invention having the above-described features, the V-belt continuously variable transmission may be installed on the power transmission deice of the electric vehicle that uses the electric motor as the driving source to perform the automatic transmission according to the driving state of the electric vehicle. Thus, in the electric vehicle, the output and performance of the electric vehicle may be improved, and also, the energy efficiency of the electric vehicle may be improved.

Also, since the elastic pressure mechanism for pressing the first second driving wheel of the driving pulley assembly toward the first driving wheel is provided, the first driving wheel may be pressed toward the second driving wheel by the centrifugal force of the weighted roller to reduce the RPM of the electric motor for the variable transmission by the elastic force of the elastic pressure mechanism that presses the second driving wheel. Thus, the gear shift timing of the continuously variable transmission may be accelerated to further improve the performance and energy efficiency of the vehicle.

Also, since the slip prevention mechanisms are respectively provided in the driving pulley assembly and the driven pulley assembly, even though the RPM of the electric motor suddenly increases for rapid acceleration during the driving or at the uphill road, the slip between the driving and driven pulley assemblies and the V-belt may be prevented.

Also, since the plurality of concave grooves are defined in the outer circumferential surface of the weighted roller constituting the driving pulley assembly of the continuously variable transmission, the friction area with respect to the weighted roller may be reduced to reduce the friction force, thereby improving the gear shift performance. In addition, since the lubricant is introduced into the plurality of concave grooves, the loss of the lubricant may be reduced, and also the lubricant may be maintained for a long time to improve the lubricant performance.

### BRIEF DESCRIPTION OF THE DRAWINGS

FIG. 1 is a cross-sectional view illustrating a power transmission device of a general gasoline engine vehicle.

FIG. 2 is a cross-sectional view illustrating a power transmission device of an electric vehicle according to the present invention.

FIG. 3 is an exploded perspective view illustrating the power transmission device of the electric vehicle according to the present invention.

FIG. 4 is an enlarged view illustrating constitutions of a driving pulley assembly of FIG. 2.

FIGS. 5 and 6 are views illustrating an operation state of a slip prevention mechanism of the driving pulley assembly in the power transmission device of the electric vehicle according to the present invention.

FIG. 7 is a perspective view of a weighted roller in the power transmission device of the electric vehicle according to the present invention.

FIG. 8 is an enlarge view illustrating constitutions of a driven pulley assembly of FIG. 2.

FIGS. 9 and 10 are views illustrating an operation state of a slip prevention mechanism of a driven pulley assembly in the power transmission device of the electric vehicle according to the present invention.

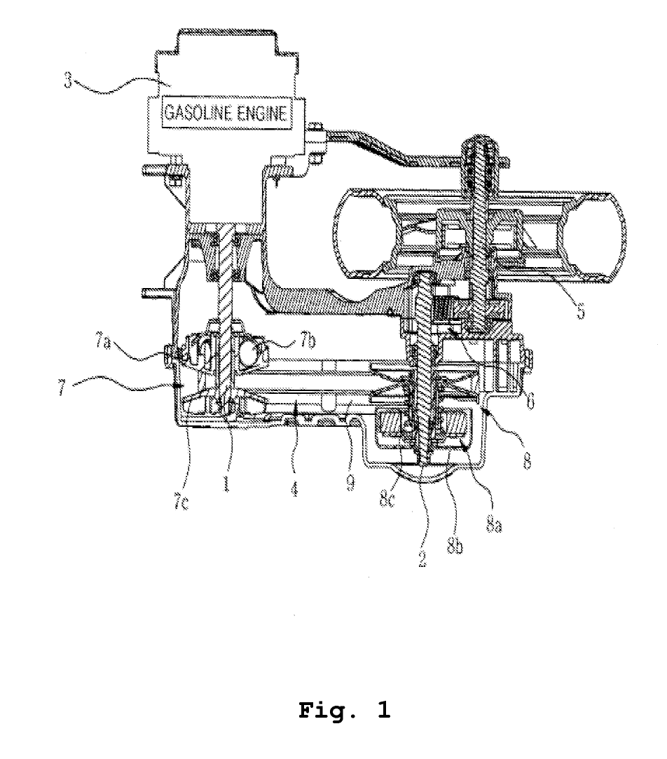

### MODE FOR CARRYING OUT THE INVENTION

Hereinafter, a power transmission device of an electric vehicle according to the present invention will be described in detail with reference to the accompanying drawings.

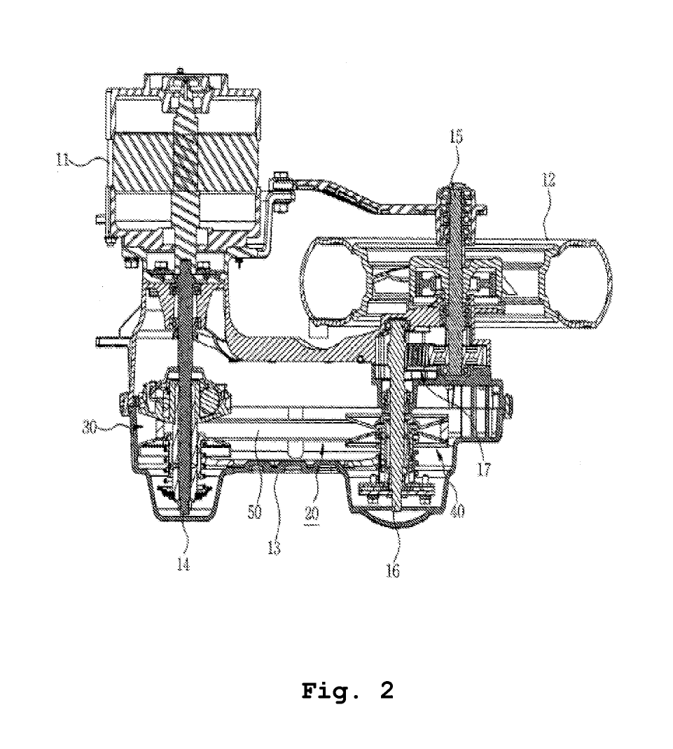

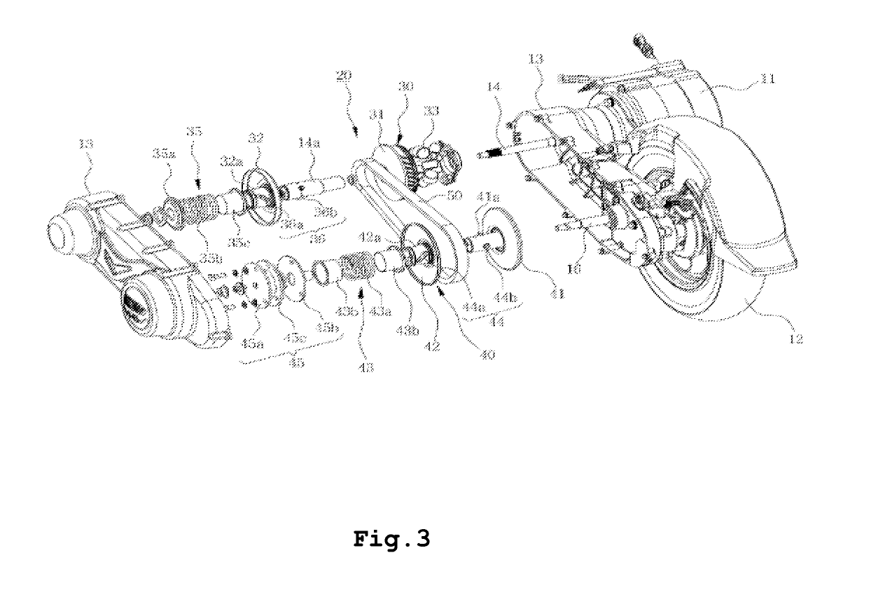

FIGS. 2 and 3 are cross-sectional and exploded perspective views of a power transmission device of an electric vehicle according to an exemplary embodiment of the present invention, respectively. As illustrated in FIGS. 2 and 3, the power transmission device of the electric vehicle includes a housing 13 for transmitting a rotational force of an electric motor 11 into a wheel 12 and fixed to a vehicle.

The electric motor 11 is disposed outside a side of the housing 13, and a driving shaft 14 is rotatably supported inside the housing 13. A wheel axis 15 of the wheel 12 passes through the housing 13 and is rotatably supported inside the housing 13. A driven shaft 16 is disposed between the driving shaft 14 and the wheel axis 15 and rotatably supported within the housing 13.

Also, a V-belt continuously variable transmission 20 is disposed between the driving shaft 14 and the driven shaft 16, and a speed-reducing gear train 17 including a plurality of gears is disposed between the driven shaft 16 and the wheel axis 15. Thus, a rotation ratio between the driving shaft 14 and the driven shaft 16 may vary by the continuously variable transmission 20, and the rotation of the driven shaft is decelerated to transmit the decelerated rotation to the wheel axis 15.

A V-belt continuously variable transmission that is widely used for a two-wheel gasoline engine vehicle may be applied to the V-belt continuously variable transmission 20. The V-belt continuously variable transmission 20 includes a driving pulley assembly 30 disposed on the driving shaft 14 of the electronic motor 11, a driven pulley assembly 40 disposed on the driven shaft 16, and a V-belt 50 connecting the driving pulley assembly 30 to the driven pulley assembly 40.

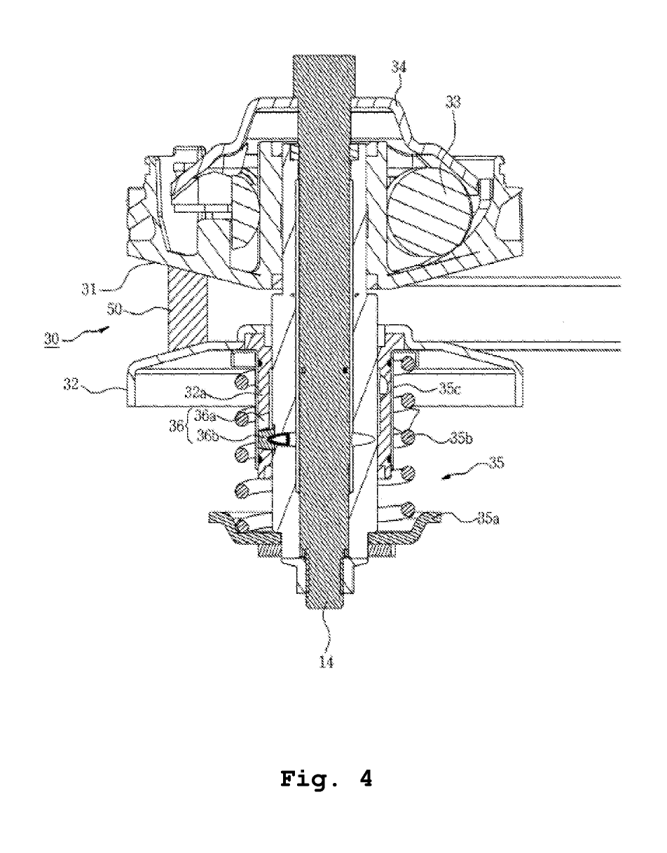

As illustrated in FIG. 4, the driving pulley assembly 30 includes a pair of first and second driving wheels 31 and 32 that face each other. The V-belt 50 is inserted and closely attached between the first and second driving wheels 31 and 32 to transmit the rotational force.

In the first and second driving wheels 31 and 32, a plurality of weighted rollers 33 are disposed on the first driving wheel 31 that is disposed at a side of the electric motor 11. Here, the plurality of weighted rollers 33 are covered by a cover 34. The plurality of weighted rollers 33 press the first driving wheel 31 toward the second driving wheel 32 by using a centrifugal force that acts when the driving shaft 14 rotates to adjust a gap between the first and second driving wheels 31 and 32.

Thus, since a supported position of the V-belt 50 that is closely attached between the first and second driving wheels 31 and 32 moves in a radius direction of each of the first and second driving wheels 31 and 32 due to the change in gap between the first and second driving wheels 31 and 32, a rotation ratio with respect to the driven pulley assembly 40 may vary to perform variable transmission. Here, in the electric vehicle that uses the electric motor 11, a revolution per minute (RPM) of the electric motor 11 at a gear shift timing, at which a centrifugal force acts on the weighted rollers 33 to perform variable transmission may be slightly different according a kind of vehicles. However, it is preferable that the RPM of the electric motor 11 is set to about 1,700 RPM or more.

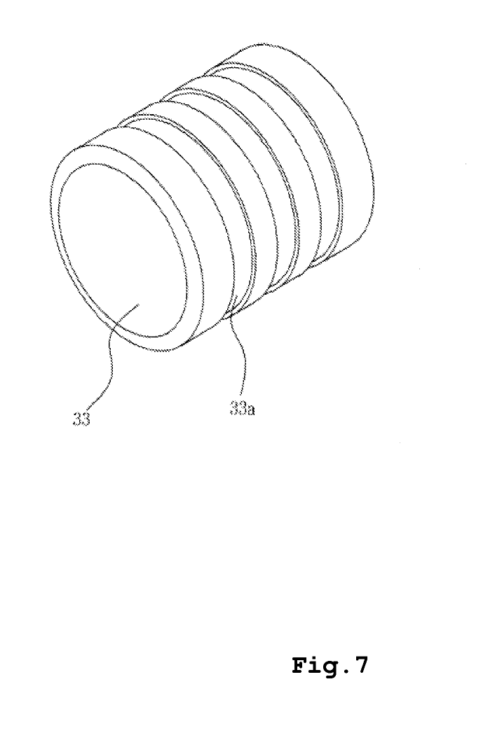

As illustrated in FIG. 7, the weighted roller 33 having the above-described function may have a plurality of concave grooves 33a in an outer circumferential surface thereof. The concave grooves 33a may reduce a frictional area with respect to the first driving wheel 31 or the cover 34 when the weighted roller 33 rotates to reduce a frictional force, thereby improving transmission performance. In addition, a lubricant (grease) may be introduced into the concave grooves 33a to maintain the transmission performance for a long time.

Referring again to FIG. 4, the driving pulley assembly 30 includes an elastic pressure mechanism 35 and a slip prevention mechanism 36. The elastic pressure mechanism 35 may apply an elastic force so that the V-belt 50 is closely attached between the first and second driving wheels 31 and 32. The elastic pressure mechanism 35 includes a support plate 35a fixed to an end of the driving shaft 14 and an elastic spring 35a elastically disposed between the support plate 35a and the second driving wheel 32. Here, a spring support 35c may be disposed between the elastic spring 35a and the second driving wheel 32.

The slip prevention mechanism 36 may prevent a slip phenomenon from occurring between the first and second driving wheels 31 and 32 and the V-belt 50. The slip prevention mechanism 36 includes an inclined cam groove 36a having a rectangular shape, which is defined in a boss part 32a of the second driving wheel 32 and cam pins 36b and 44b fixed to the driving shaft 14 and guided toward the inclined cam groove 36a. The cam pin 36b may be directly disposed on the driving shaft 14. However, in the current embodiment, the cam pin 36b may be fixed to a rotatable support boy 14a fixed to the outer circumference of the driving shaft 14 to rotate together with the driving shaft 14.

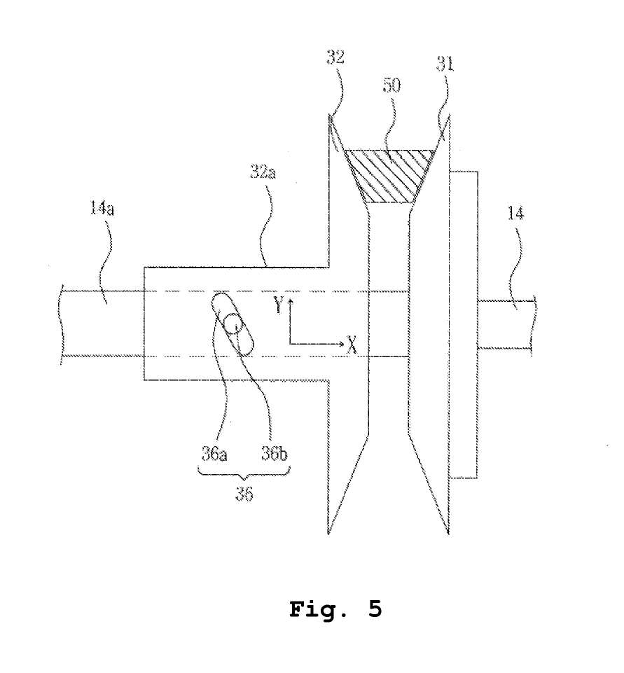

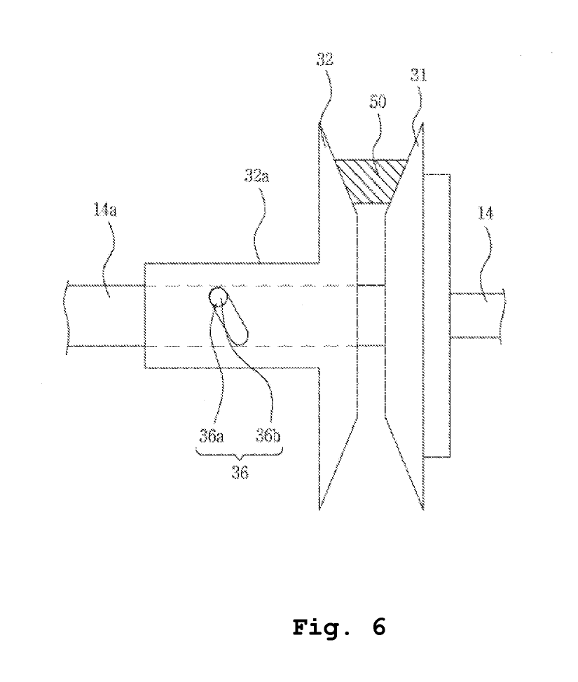

The inclined cam groove 36a having the rectangular shape may be inclined so that the cam pin 36b pushes the second driving wheel 32 toward the first driving wheel 31 to move when the second driving wheel 32 has a rotation speed greater than that of the driving shaft 14. That is, as illustrated in FIGS. 5 and 6, when the rotation speed of the driving shaft 14 is greater than that of the second driving wheel 32, the second driving wheel 32 may be relatively stopped, and the cam pin 36b may further rotate by a rotation speed difference in the rotating direction (an arrow Y direction in FIG. 5). Thus, the inclined cam groove 36a may be inclined so that the second driving wheel 32 moves toward the first driving wheel 31 (an arrow X direction) by using the rotation of the cam pin 36b. Thus, since the second driving wheel 32 moves to further narrow the gap between the first and second driving wheels 31 and 32, the V-belt 50 may be more closely attached between the first and second driving wheels 31 and 32 to prevent the slip phenomenon from occurring.

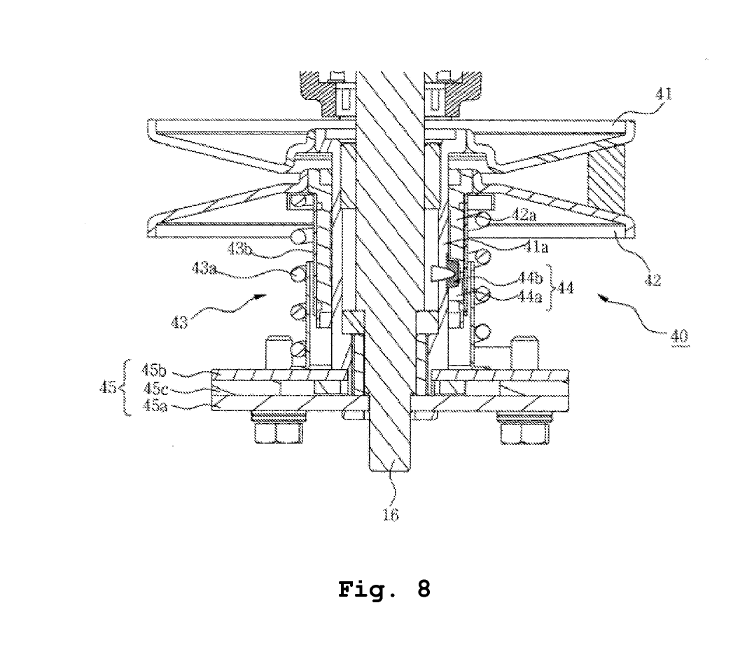

As illustrated in FIG. 8, the driven pulley assembly 40 includes a pair of first and second driven wheels 41 and 42 that face each other. The V-belt is inserted and closely attached between the first and second driven wheels 41 and 42 to transmit the rotational force.

Also, the driven pulley assembly 40 includes an elastic pressure mechanism 43 and a slip prevention mechanism 44. The elastic pressure mechanism 43 may apply an elastic force so that the V-belt 50 is closely attached between the first and second driven wheels 41 and 42. The elastic pressure mechanism 35 includes a fixed plate 45 fixed to an end of the driven shaft 16 and an elastic spring 43a elastically disposed between the fixed plate 45 and the second driven wheel 42.

Here, a spring support 43b may be disposed each of between the fixed plate 45 and the elastic spring 43a and between the elastic spring 43a and the second driven wheel 42. Also, the fixed plate 45 may be provided as a single part. However, in the current embodiment, for manufacturability, the fixed plate 45 may include a first fixed member 45a fixed to the driven shaft 16, a second fixed member 45b closely attached to an end of the elastic spring 43a, and a third fixed member 45c disposed between the first fixed member 45a and the second fixed member 45b to connect the first fixed member 45a to the second fixed member 45b.

The slip prevention mechanism 44 may prevent a slip phenomenon from occurring between the driven pulley assembly 40 and the V-belt 50. The slip prevention mechanism 44 includes an inclined cam groove 44a having a rectangular shape, which is defined in a boss part 42a of the second driven wheel 42 and a cam pin 44b fixed to the boss part 41a of the first driven wheel 41 and guided toward the inclined cam groove 44a.

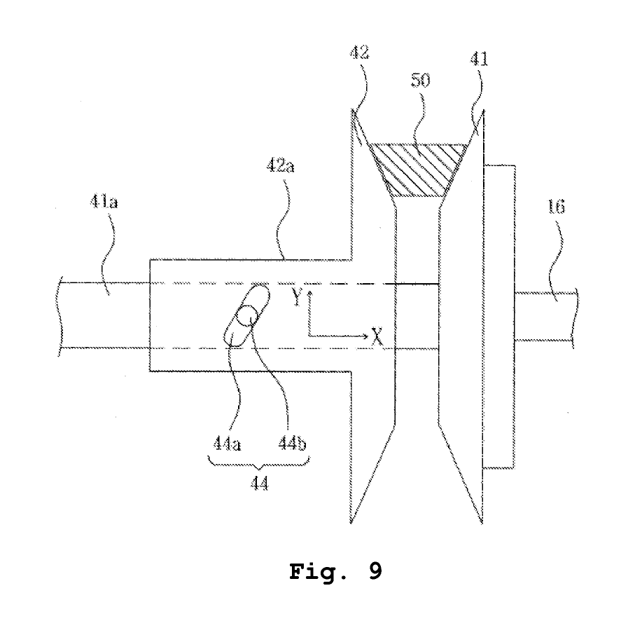

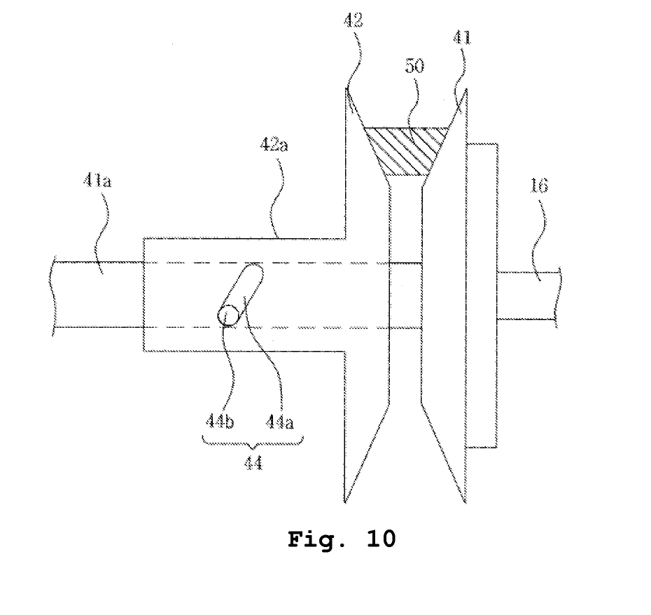

The inclined cam groove 44a having the rectangular shape may be inclined so that the cam pin 44b pushes the second driven wheel 42 toward the first driven wheel 41 to move, thereby preventing the slip phenomenon from occurring when the second driven wheel 42 has a rotation speed greater than that of the first driven wheel 41. That is, as illustrated in FIGS. 9 and 10, when the rotation speed of the driven shaft 42 is relatively greater than that of the second driven wheel 41, the cam pin 44b of the first driven wheel 41 may be relatively stopped, and the inclined groove 44a of the second driven wheel 42 may further rotate by a rotation speed difference in the rotating direction (the arrow Y direction in FIG. 9). Thus, the inclined cam groove 44a may be inclined so that the inclined cam groove 44a is guided to the cam pin 44b by using the rotation thereof to allow the second driven wheel 42 to move toward the first driven wheel 41 (the arrow X direction). Thus, since the second driven wheel 42 moves to further narrow the gap between the first and second driven wheels 41 and 42, the V-belt 50 may be more closely attached between the first and second driven wheels 41 and 42 to prevent the slip phenomenon from occurring.

An operation of the power transmission device including the above-described constitutions will be described below. As illustrated in FIG. 2, when a power is supplied into the electric motor 11 to allow the electric vehicle to rotate at a gear shift starting speed of the electric vehicle, for example, at a low speed of about 1,700 RPM or less (that is different according to a kind of vehicles), since the centrifugal force of the weighted roller 33 disposed on the driving pulley assembly 30 does not act, the variable transmission may not be performed. However, since the V-belt 50n is closely attached between the first and second driving wheels 31 and 32 by the elastic spring 35a of the elastic pressure mechanism 35 in the driving pulley assembly 30, and the V-belt 50 is closely attached between the first and second driven wheels 41 and 42 by the elastic spring 43a of the elastic pressure mechanism 43, the rotation of the driving shaft 14 may be transmitted into the driven shaft 16 through the driving pulley assembly 30, the driven pulley assembly 40, and the V-belt 50, and the rotation of the driven shaft 16 may be decelerated by the speed-reducing gear train 17 and be transmitted into the wheel axis 15 to allow the vehicle to rotate at the low speed. Here, a pressing force applied to each of the elastic springs 35b and 43a may be preset so that the V-belt 50 is closely attached to the innermost circumference at the first and second driving wheels 31 and 32 of the driving pulley assembly 30 and closely attached to the outermost circumference at the first and second driven wheels 41 and 42 of the driven pulley assembly 40. Thus, an initial ration ratio of the driven shaft 16 to the driving shaft 14 may be maintained to about 2.5:1 due to a difference between diameters of the driving pulley assembly 30 and the driven pulley assembly 40, which support the V-belt 50.

In the state where the vehicle rotates at the low speed, if the RPM of the electric motor 11 increases to the gear shift starting speed, i.e., about 1,700 RPM or more to perform the variable transmission, the centrifugal force may act on the weighted roller 33 of the driving pulley assembly 30 to press the first driving wheel 31 toward the second driving wheel 32. As a result, since the gap between the first driving wheel 31 and the second driving wheel 32 is narrowed to allow the V-belt 50 to be pushed outward from a rotational center, the supported portion of the V-belt 50 may increase in diameter, and thus, the rotation ratio with respect to the driven pulley assembly 40 may vary to perform the variable transmission.

The rotation ration may be automatically adjusted according to the variation in gap between the first and second driving wheels 31 and 32 by adjusting the centrifugal force of the weighted roller 33 due to the variation in the RPM of the electric motor 11.

Thus, in the electric vehicle, the automatic transmission of the vehicle may also be performed according to the driving state of the vehicle to improve the output, performance, and energy efficiency of the vehicle.

Also, according to the present invention, the elastic spring 35a of the elastic pressure mechanism 35 disposed on the driving pulley assembly 30 may press the second driving wheel 32 toward the first driving wheel 31. Thus, a time at which the centrifugal force of the weighted roller 33 acts for the gear shaft starting may be reduced by the acting elastic force of the elastic spring 35a, and also, the centrifugal force of the weighted roller 33 may act even in the state where the RPM of the electric motor 11 is reduced to perform the automatic transmission. Therefore, the gear shift timing of the continuously variable transmission 20 may be accelerated to improve the output and performance and save the energy.

Also, when the RPM of the electric motor 11 suddenly increases for rapid acceleration during the driving or at an uphill road, the slip phenomenon that may occur between the first and second driving wheels 31 and 32 of the driving pulley assembly 30 and the V-belt 50 or between the first and second driven wheels 41 and 42 of the driven pulley assembly 40 and the V-belt 50 may be prevented by the slip prevention mechanisms 36 and 44 that are respectively disposed on the driving pulley assembly 30 and the driven pulley assembly 40.

That is, as illustrated in FIGS. 5 and 6, in the driving pulley assembly 30, when the RPM of the electric motor 11 suddenly increases during the driving or at an uphill road, since the rotation speed of the driving shaft 14, which is directly transmitted from the electric motor 11, suddenly increases, the slip may occur between the first and second driving wheels 31 and and the V-belt 50, and thus, the first and second driving wheels 31 and 32 may become to the relatively stopped state. In addition, the cam pin 36b rotating together with the driving shaft 14 may further rotate in the arrow Y direction.

Thus, since the cam pin 36b is guided to the inclined cam groove 36a of the second driving wheel 32 to push and move the second driving wheel 32 in the arrow X direction, the gap between the first and second driving wheels 31 and 32 may be narrowed to allow the V-belt to be closely attached between the first and second driving wheels 31 and 32. Therefore, the slip between the first and second driving wheels 31 and 32 and the V-belt 50 may be prevented to transmit the rotation force of the driving shaft 14 into the driven pulley assembly 40.

Also, as illustrated in FIGS. 9 and 10, in the driven pulley assembly 40, when the RPM of the electric motor 11 suddenly increases during the driving or at an uphill road, the slip may occur between the first and second driven wheels 41 and and the V-belt 50, and thus, the cam pin 44b of the first driven wheel 41 fixed to the driven shaft 16 may become to the relatively stopped state. Therefore, the inclined cam groove 44a of the second driven wheel 42 that receives the rotation force from the driving pulley assembly 30 through the V-belt 50 may further rotate in the arrow Y direction. Thus, since the cam pin 44b is guided to the inclined cam groove 44a to push and move the second driven wheel 42 in the arrow X direction, the gap between the first and second driven wheels 41 and 42 may be narrowed to allow the V-belt to be closely attached between the first and second driven wheels 41 and 42. Therefore, the slip between the first and second driven wheels 41 and 42 and the V-belt 50 may be prevented to transmit the rotation force of the driving shaft 14 into the driven shaft 16.

Although an exemplary embodiment of the present invention has been shown and described, it should be apparent to those having ordinary skill in the art that various changes, modifications, or alterations to the invention as described herein may be made, none of which change the spirit of the present invention. All changes, modifications, or alterations should therefore be seen as within the scope of the invention.

### DESCRIPTION OF THE SYMBOLS

11: Electric motor 12: Wheel

13: Housing 14: Driving shaft

15: Wheel axis 16: Driven shaft

17: Speed-reducing gear train 20: Continuously variable transmission

30: Driving pulley assembly 31, 32: First and second driving wheels

32a, 41a, 42a: Boss part 33: Weighted roller

33a: Concave groove 35, 43: Elastic pressure mechanism

36, 44: Slip prevention mechanism 35b, 43a: Elastic spring

36a, 44a: Inclined cam groove 36b, 44b: Cam pin

41, 42: First and second driven wheel 50: V-belt

1. A power transmission device of an electric vehicle comprising a continuously variable transmission, the power transmission device comprising:
a housing;
a driving pulley assembly disposed on a driving shaft of the electric motor that is rotatably supported inside the housing;
a driven pulley assembly disposed on a driven shaft that is rotatably supported inside the housing;
a V-belt connecting the driving pulley assembly to the driven pulley assembly; and
a speed-reducing gear train disposed between a wheel axis that is rotatably supported inside the housing and the driven shaft,
wherein the driving pulley assembly comprises:
a pair of first and second driving wheels that face each other;
a plurality of weighted rollers disposed on first driving wheel to adjust a gap between the first and second driving wheels by using a centrifugal force that acts when the driving shaft rotates;
an elastic pressure mechanism disposed on the second driving wheel to apply an elastic force to the second driving wheel, thereby allowing the V-belt to be closely attached between the first and second driving wheels,
wherein the driven pulley assembly comprises:
a pair of first and second driven wheels; and
an elastic pressure mechanism disposed on the second driven wheel to apply an elastic force to the second driven wheel, thereby allowing the V-belt to be closely attached between the first and second driven wheels.

2. The power transmission device according to claim 1, wherein the elastic pressure mechanism of the driving pulley assembly comprises:
a support plate fixed to an end of the driving shaft; and
an elastic spring elastically disposed between the support plate and the second driving wheel.

3. The power transmission device according to claim 1, wherein the elastic pressure mechanism of the driven pulley assembly comprises:
a fixed plate fixed to an end of the driven shaft; and
an elastic spring elastically disposed between the fixed plate and the second driven wheel.

4. The power transmission device according to claim 1, wherein slip prevention mechanisms for preventing slip from occurring with respect to the V-belt are disposed on the driving pulley assembly and the driven pulley assembly, respectively.

5. The power transmission device according to claim 4, wherein the slip prevention mechanism disposed on the driving pulley assembly comprises:
an inclined cam groove having a rectangular shape, the inclined cam groove being defined in a boss part of the second driving wheel; and
a cam pin fixed to the driving shaft, the cam being guided into the inclined cam groove,
wherein the inclined cam groove is inclined so that, when a rotation speed of the driving shaft is greater than that of the second driving wheel, the cam pin pushes the second driving wheel toward the first driving wheel to allow the second driving wheel to move.

6. The power transmission device according to claim 4, wherein the slip prevention mechanism disposed on the driven pulley assembly comprises:
an inclined cam groove having a rectangular shape, the inclined cam groove being defined in a boss part of the second driven wheel; and
a cam pin fixed to a boss part of the first driven wheel, the cam being guided into the inclined cam groove,
wherein the inclined cam groove is inclined so that, when a rotation speed of the second driven wheel is greater than that of the first driving wheel, the cam pin pushes the second driven wheel toward the first driven wheel to allow the second driven wheel to move.

7. The power transmission device according to claim 1, wherein a plurality of concave grooves are defined in an outer circumferential surface of each of the weighted roller.
